(19) United States
(12) Patent Application Publication
(10) Pub. No.: US 2012/0308285 A1
(43) Pub. Date: Dec. 6, 2012

(54) AUTO-DOCUMENT FEEDER AND AUTO-DOCUMENT FEEDING METHOD

(75) Inventors: Naoki Shoji, Kanagawa (JP); Shinji Miwa, Tokyo (JP); Shoichi Taniguchi, Shizuoka (JP); Osamu Kitazawa, Shizuoka-ken (JP); Akihito Tokutsu, Kanagawa (JP); Seiji Iino, Kanagawa (JP); Mitsunori Ishii, Tokyo (JP); Takeshi Kojima, Shizuoka (JP); Takeshi Ito, Shizuoka (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/360,972

(22) Filed: Jan. 30, 2012

Related U.S. Application Data
(60) Provisional application No. 61/493,708, filed on Jun. 6, 2011.

(51) Int. Cl. G03G 13/00; G03G 15/00

(52) U.S. Cl. 399/367

(57) ABSTRACT

An auto-document feeder includes plural conveying sections which have different paths to reach an image scanning section configured to scan an image on a document from a paper feeding section and which guide the document to the image scanning section, a scanning conveying section configured to alternately nip the documents one by one fed by the plural conveying sections and feed the documents in a direction of a paper discharge section through the image scanning section, a gate section which directs the documents to one of the plural conveying sections, and a detecting section configured to detect if a document is fed by the paper feeding section.

### CROSS-REFERENCE TO RELATED APPLICATIONS

This application is based upon and claims the benefit of priority from U.S. Provisional Application Ser. No. 61/493,708 filed on Jun. 6, 2011, the entire contents of which are incorporated herein by reference.

### FIELD

This disclosure relates to an auto document feeding device which conveys a document to an image scanning device used for a copy machine, printer, or the like which facilitates high-speed scanning.

### BACKGROUND

In an image scanning device such as a scanner used for an image forming apparatus such as a copy machine or printer, an increase in the image scanning speed is desired. Conventionally, there is a device in which plural document scanning conveying paths are formed and in which a scanning sensor for scanning a face-side image of the document and a scanning sensor for scanning a back-side image are provided in different conveying paths, thereby increasing the scanning speed at the time of double-side scanning of the document images. As such an image scanning device, for example, a device can have a first branch path through which a document is conveyed to a first scanning position, and a second branch path through which a document is conveyed to a second scanning position. Moreover, for example, a device can have a scanner device and a CIS (contact image sensor) provided on the opposite sides of a first conveying path and simultaneously uses the scanner device and the CIS to scan both sides of a document conveyed on the first conveying path.

### DESCRIPTION OF THE DRAWINGS

FIG. 1 is a configuration view schematically showing an image scanning device according to an embodiment;

FIG. 2 is a block diagram showing a control system of an ADF according to an embodiment;

FIG. 3 is a flowchart showing operations from turning on power to starting supply of a document according to an embodiment;

FIG. 4 is a flowchart showing operations to supply the document and convey the document to an OUT conveying member according to an embodiment;

FIG. 5 is a flowchart showing an operation to convey the document by using OUT conveying member according to an embodiment;

FIG. 6 is a flowchart showing operations from the start of scanning of an image to the end of scanning; and

FIG. 7 is a flowchart showing an operation to convey a following document by using an IN conveying member according to an embodiment; and

FIG. 8 is a flowchart showing completion of the conveying according to an embodiment.

### DETAILED DESCRIPTION

According to an embodiment, an auto-document feeder includes a paper feeding section configured to feed documents one by one, from which images are read by an image scanning section; a paper discharge section which discharges the documents that have passed through the image scanning section; plural conveying sections which have different paths to reach an image scanning section configured to scan an image on a first side of the documents from the paper feeding section and which guide the documents from the paper feeding section to the image scanning section; a scanning conveying section configured to alternately nip the documents one by one fed by the plural conveying sections and feed the documents in a direction of the paper discharge section through the image scanning section; a gate section which divides the documents, which have been fed by the paper feeding section, to one of the plural conveying sections; and a detecting section configured to detect if a document is fed by the paper feeding section.

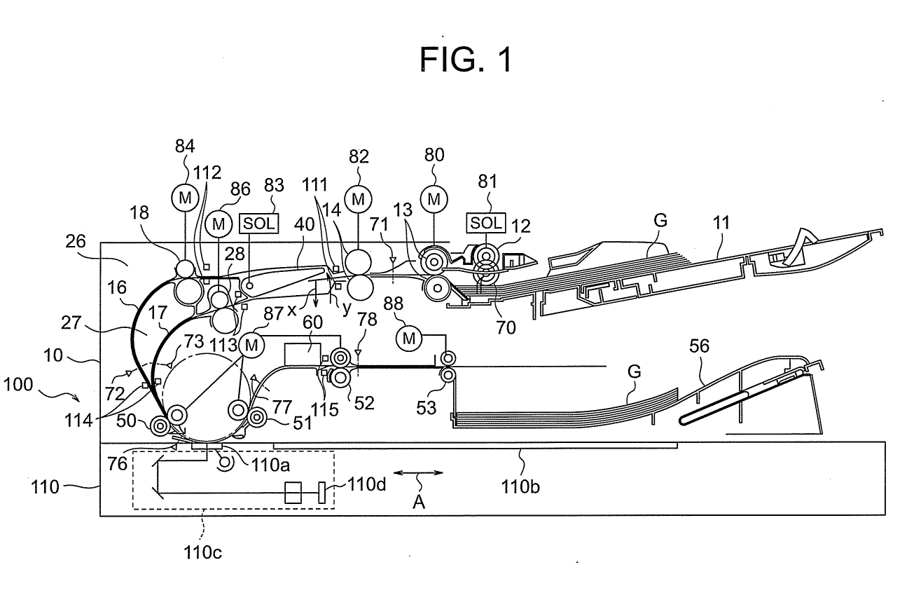

Hereinafter, an embodiment is described. FIG. 1 shows an image scanning device 100 according to the embodiment. The image scanning device 100 has a scanner 110, which is an image scanning member, and an auto document feeding device (ADF) 10 which conveys a document G to the scanner 110. The scanner 110 has a READ document glass 110a and a platen glass 110b of a document setting table. The scanner 110 also has an optical mechanism 110c. The optical mechanism 110c optically scans an image of the document G traveling on the READ document glass 110a. Alternatively, a driving unit, not shown, moves the optical mechanism 110c in the direction of arrow A (see FIG. 1) along the platen grass 110b, and optically scans the image of the document G set on the Platen glass 110b. The scanner 110 has a photosensor, such as a CCD (charge coupled device) 110d which photoelectrically converts an optical signal from the optical mechanism 110c to an electric signal.

The auto document feeding device 10 has a document tray 11, which is a document stacking member, a pickup roller 12 which takes out the document G from the document tray 11, separation paper supply rollers 13 which prevent double feeding of the two or more document Gs, and registration rollers 14 which align the forward end of document G removed and conveyed from the document tray 11. And there is a gate piezoelectric sensor 111 downstream of the registration rollers 14. The auto document feeding device 10 in this embodiment has two paths as conveying paths; namely, an OUT path 16 from the registration rollers 14 to the scanner 110, and an IN path 17 from the registration rollers 14 to the scanner 110. The OUT path 16, together with the document tray 11, the pickup roller 12, the separation paper supply roller 13, and the registration rollers 14, forms an OUT conveying member 26, as a first conveying member, for example. The IN path 17, together with the document tray 11, the pickup roller 12, the separation paper supply rollers 13, and the registration rollers 14, forms an IN conveying member 27, as a second conveying member, for example.

The OUT path 16 has intermediate OUT rollers 18. There is intermediate OUT path piezoelectric sensor 112 in upstream of the intermediate OUT rollers 18. The IN path 17 has intermediate IN rollers 28. There is an intermediate IN path piezoelectric sensor 113 upstream of the intermediate IN rollers 28. The auto document feeding device 10 has a gate 40 which directs the document G taken out from the document tray 11 and passed through the registration rollers 14, to the OUT path 16 or the IN path 17.

The auto document feeding device 10 has pre-scan rollers 50 which conveys the document G that has passed through the OUT path 16 or the IN path 17 to the READ document glass 110a of the scanner 110; post-scan rollers 51 which discharge the document G from the READ document glass 110a; pre-discharge rollers 52; paper discharge rollers 53; and a paper discharge tray 56. There is a pre-scan piezoelectric sensor 114 upstream of the pre-scan rollers 50. There is a pre-discharge piezoelectric sensor 115 upstream of the pre-discharge rollers 52. The post-scan rollers 51, the pre-discharge rollers 52, and the paper discharge rollers 53 form a paper discharge member. A contact image sensor (CIS) 60, which is a second image scanning member, is provided between the post-scan rollers 51 and the pre-discharge rollers 52. The contact image sensor (CIS) 60 can be provided in a conveying path upstream of the paper discharge rollers 53.

On the READ document glass 110a, an image on the face side as a first side of the traveling document G is scanned. The CIS 60 scans an image on the backside as a second side of the traveling document G. Thus, it is possible to scan the images on both sides of the document G by passing the document only once in the conveying path.

An empty sensor 70 which detects the presence or absence of the document G is provided above the document tray 11. A registration sensor 71 which detects arrival of the document G at the registration rollers 14 is provided between the separation paper supply rollers 13 and the registration rollers 14. In the OUT path 16, a paper timing sensor OUT 72 as a first timing sensor which detects the drive timing of the registration rollers 14 and the intermediate OUT rollers 18 is provided. In the IN path 17, a paper timing sensor IN 73 as a second timing sensor which detects the drive timing of the registration rollers 14 and the intermediate IN rollers 28 is provided. A pre-scan sensor 76 is provided between the pre scan rollers 50 and the READ document glass 110a. A scan sensor 77 is provided between the post-scan rollers 51 and the pre-discharge rollers 52. A paper discharge sensor 78 is provided between the pre-discharge rollers 52 and the paper discharge rollers 53.

A paper supply motor 80 drive the pickup roller 12 and the separation paper supply rollers 13 to rotate. A pickup solenoid 81 causes the pickup roller 12 to fluctuate. A registration motor (RGT motor) 82 drives the registration rollers 14 to rotate. The gate 40 is switched by a gate solenoid 83. When the gate solenoid 83 is turned off, the gate 40 turns in the direction of arrow x and directs the document G to the OUT conveying member 26. When the gate solenoid 83 is turned on, the gate 40 turns in the direction of arrow y and directs the document G to the IN conveying member 27.

An intermediate OUT motor 84 drives the intermediate OUT rollers 18 to rotate. An intermediate IN motor 86 drives the intermediate IN rollers 28 to rotate. A READ motor 87 drives the pre-scan rollers 50, the post-scan rollers 51, and the pre-discharge rollers 52 to rotate. A paper discharge motor 88 drives the paper discharge rollers 53 to rotate.

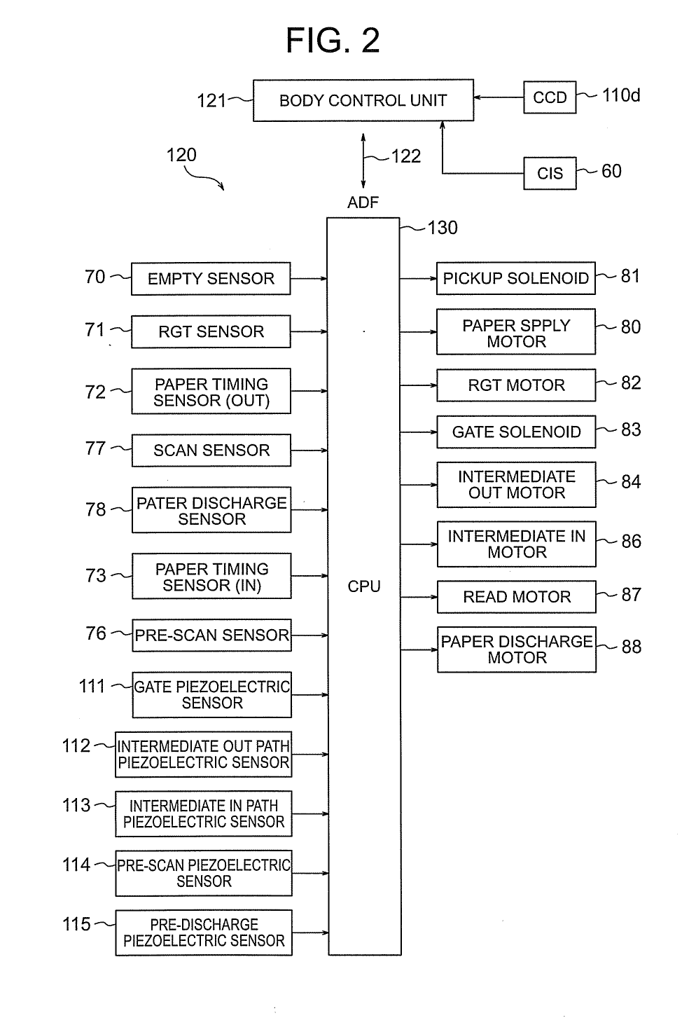

FIG. 2 shows a block diagram of a control system 120 suitable for use with the ADF 10. The CCD 110d of the scanner 110 and the CIS 60 are connected to a body control unit 121 which controls, for example, an entire image forming apparatus having the image scanning device 100. The body control unit 121 controls a CPU 130 of the ADF 10 via an input-output interface 122. The empty sensor 70, the registration sensor 71, the paper timing sensor OUT 72, the paper timing sensor IN 73, the pre-scan sensor 76, the scan sensor 77, the paper discharge sensor 78, the gate piezoelectric sensor 111, the intermediate OUT path piezoelectric sensor 112, the intermediate IN path piezoelectric sensor 113, the pre-scan piezoelectric sensor 114, and pre-discharge piezoelectric sensor 115 are connected to the input side of the CPU 130.

The pickup solenoid 81, the paper supply motor 80, the RGT motor 82, the gate solenoid 83, the intermediate OUT motor 84, the intermediate IN motor 86, the READ motor 87, and the paper discharge motor 88 are connected to the output side of the CPU 130.

Here, the gate piezoelectric sensor 111, the intermediate OUT path piezoelectric sensor 112, the intermediate IN path piezoelectric sensor 113, the pre-scan piezoelectric sensor 114, and the pre-discharge piezoelectric sensor 115 are explained. When the document G is conveyed normally (without an undesirable event), these piezoelectric sensors do not detect pressure.

When a pressure greater than a threshold value is detected by the piezoelectric sensors, CPU 130 determines that the document G under conveyance is bent unusually. And CPU 130 determines that a jam exists.

When the pressure is detected for more than predetermined time, although the pressure value detected by the piezoelectric sensor does not exceed a threshold value, CPU 130 determines that the document Gunder conveyance is in an abnormal state. And CPU 130 determines that a jam exists.

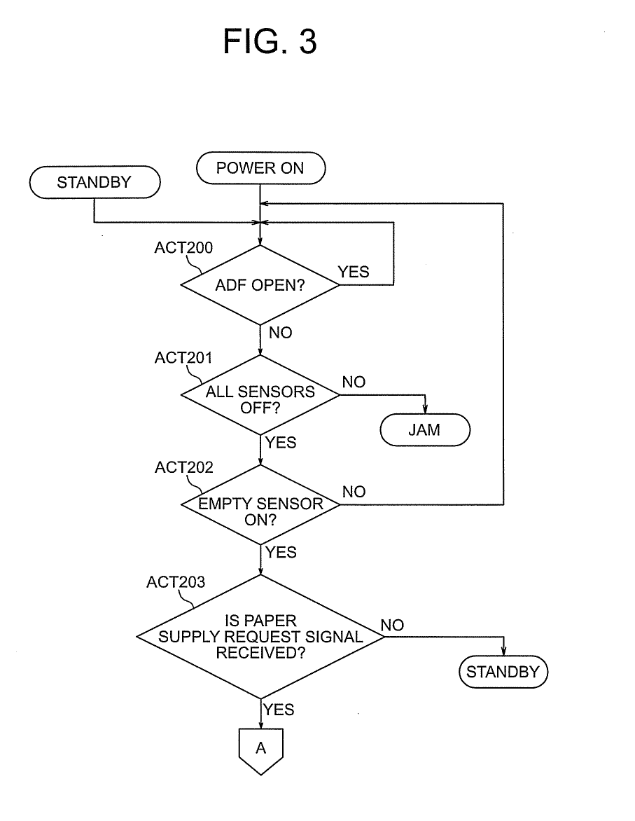

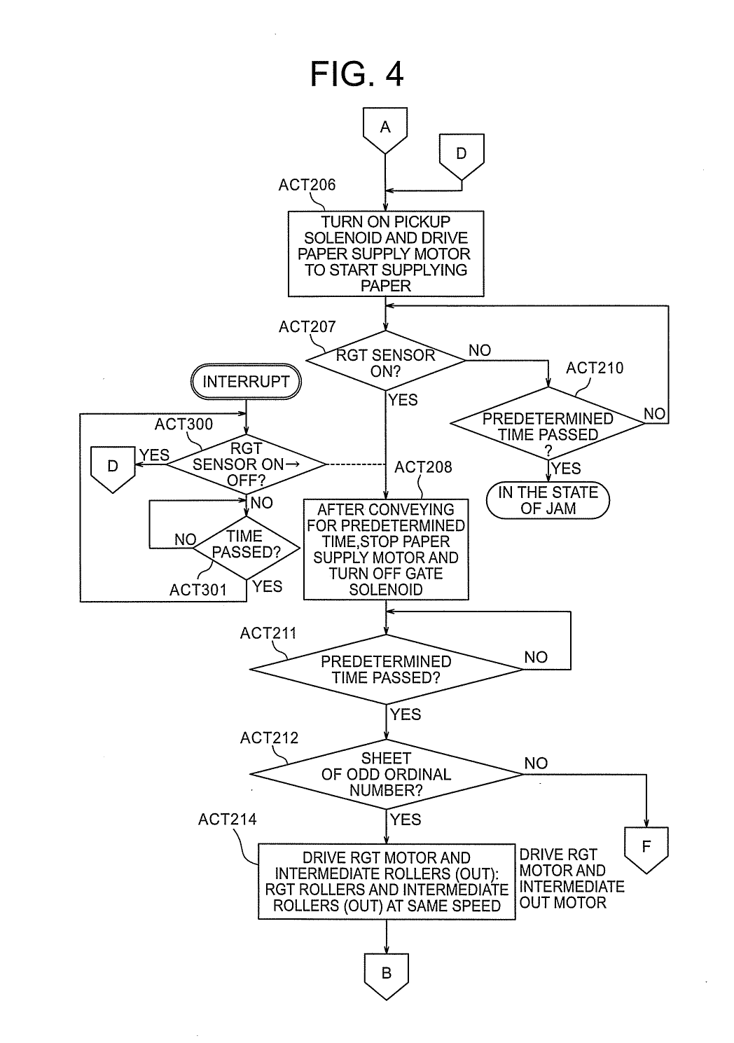

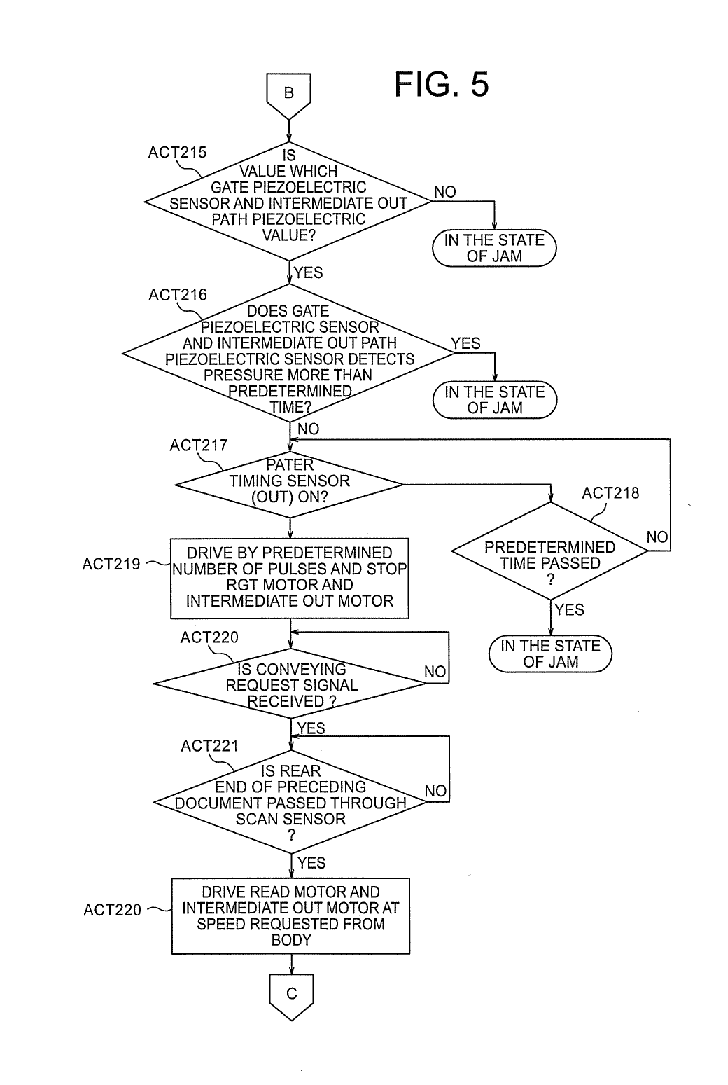

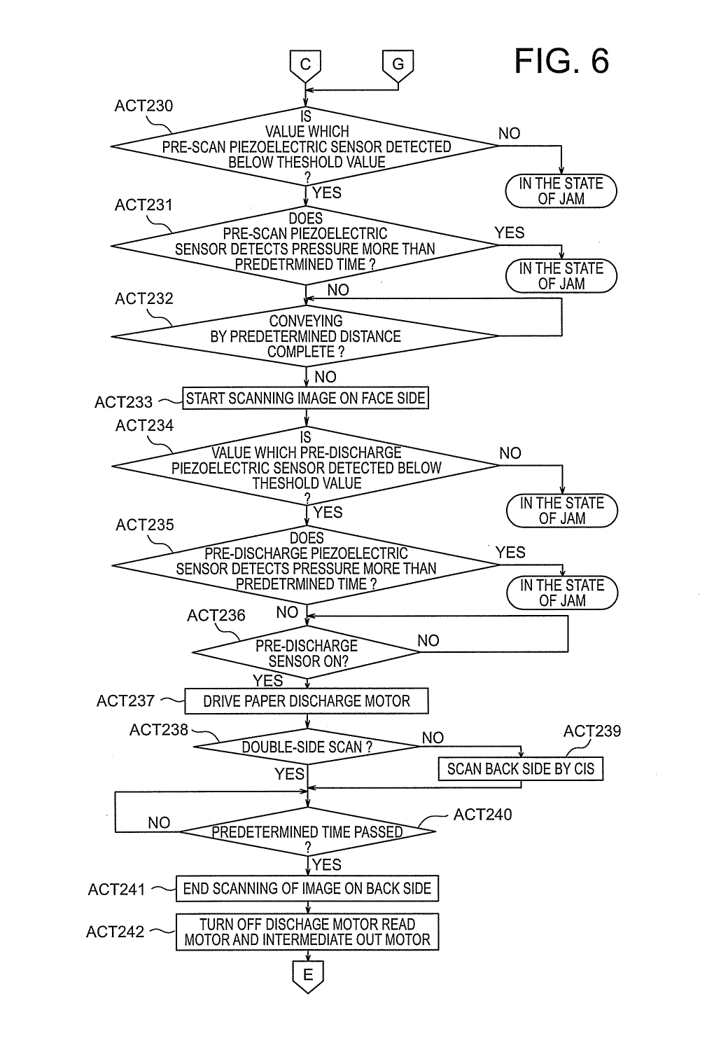

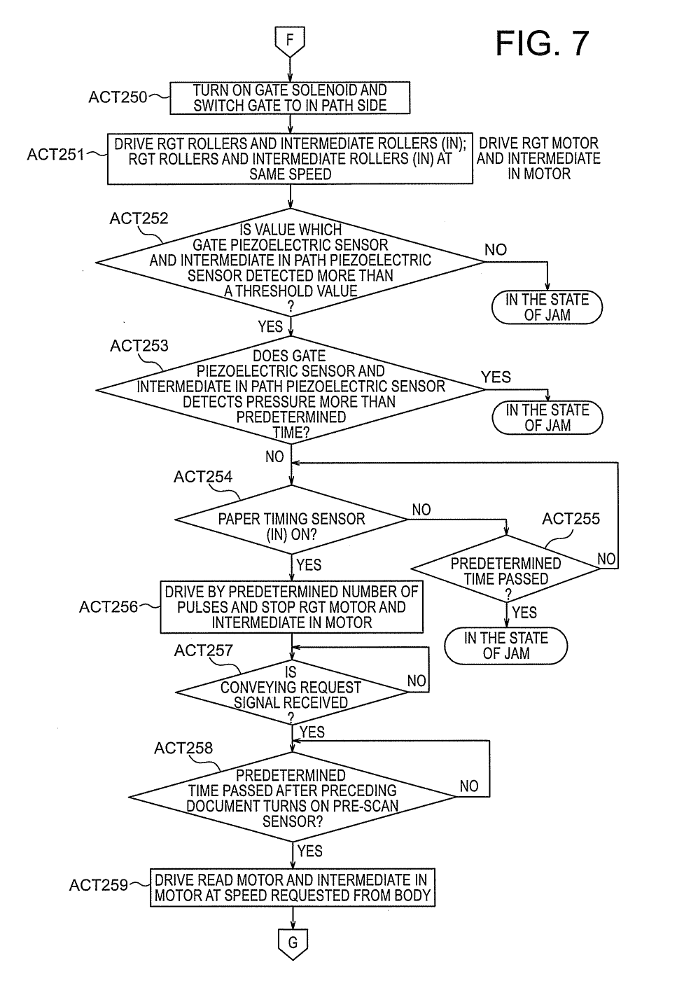

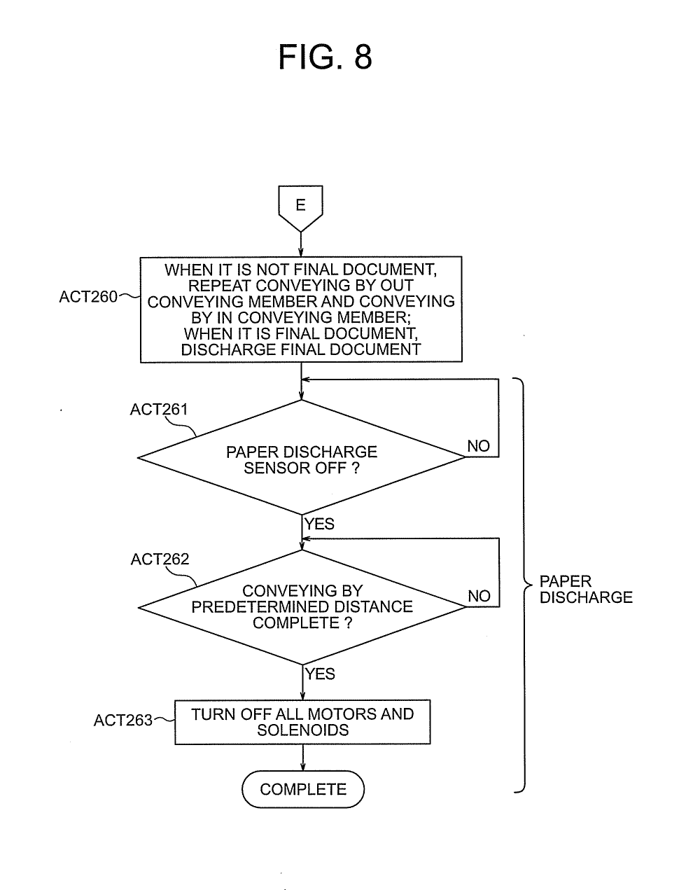

A process of continuously conveying documents G is described with reference to the flowcharts of FIG. 3 to FIG. 8. After power is turned on, it is confirmed in ACT 200 that the ADF 10 is closed. Detection is conveyed out at all the sensors in ACT 201 to confirm that there is no jam of documents in the ADF 10 that is closed. When the document G is set on the document tray 11 in ACT 202, the empty sensor 70 turns on and sends a document-on signal to the body control unit 121. After a paper supply request signal is received from the body control unit 121 in ACT 203, the processing goes to ACT 206.

In ACT 206, the pickup solenoid 81 is turned on and the paper supply motor 80 is turned on to rotate the pickup roller 12 and the separation paper supply rollers 13. As a result, supply of the document G1 as the first sheet (the first document G1) is started. When the registration sensor 71 turns on in ACT 207, the document G1 is conveyed for a predetermined time and then the paper supply motor 80 is turned off and the gate solenoid 83 is turned off (ACT 208). The first document G1 runs into the registration rollers 14 and/its forward end is aligned and then the first document G1 stops. The gate 40 is set in the direction of directing the first document G1 to the OUT conveying member 26. If the registration sensor 71 does not turn on even after the lapse of a predetermined time in ACT 210, it is determined that the document G1 causes or is involved in a jam.

When the registration sensor 71 turns on in ACT 207, the supply process of the document G2 as the second sheet (the second document G2) starts as an interruption process, separately from and parallel to the conveying process of the first document G1. However, the supply process of the second document G2 remains idle until the rear end of the first document G1 passes through the registration sensor 71. After the registration sensor 71 changes from on to off in ACT 300 (ACT 301), the processing goes to ACT 206 and supply of the second document G2 starts.

After a predetermined time passes in ACT 211 and the document G1 is a sheet of an odd ordinal number (ACT 212), the RGT motor 82 and the intermediate OUT motor 84 are turned on to rotate the registration rollers 14 and the intermediate OUT rollers 18 (ACT 214), respectively. The intermediate OUT rollers 18 are adjusted to the rotation speed of the registration rollers 14, and the registration rollers 14 and the intermediate OUT rollers 18 are rotated at a uniform velocity. The first document G1 is directed by the gate 40 and moves to the OUT conveying member 26.

When the value which the gate piezoelectric sensor 111 and the intermediate OUT path piezoelectric sensor 112 detected is greater than a threshold value, it is determined that a jam exists (ACT 215). When the value which the gate piezoelectric sensor 111 and the intermediate OUT path piezoelectric sensor 112 detected is below a threshold value, the processing goes to ACT 216. When the gate piezoelectric sensor 111 and the intermediate OUT path piezoelectric sensor 112 detect pressure greater than predetermined time, it is judged as jam (ACT216). When the gate piezoelectric sensor 111 and the intermediate OUT path piezoelectric sensor 112 do not detect pressure more than predetermined time, the processing goes to ACT 217.

When the paper timing sensor OUT 72 turns on in ACT 217, the RGT motor 82 and the intermediate OUT motor 84 are driven for a predetermined number of pulses and then stopped (ACT 219). The first document G1 stops before the pre-scan rollers 50. If the paper timing sensor OUT 72 does not turn on even after the lapse of a predetermined time in ACT 218, it is judged that the document G1 causes a jam.

After a conveying request signal is received from the body control unit 121 in ACT 220, the processing goes to ACT 221. When the scanner 110 can scan, the body control unit 121 sends a conveying request signal to the CPU 130. When there is a preceding document G, and when a predetermined time passes after the forward end of the preceding document G turns on the pre-scan sensor 76 (ACT 221), the processing goes to ACT 222.

In ACT 222, the READ motor 87 and the intermediate OUT motor 84 are turned on to rotate the intermediate OUT motor 84 are turned on to rotate the intermediate OUT rollers 18, the pre-scan rollers 50, the post-scan rollers 51, and the pre-discharge rollers 52 at a suitable speed according to an instruction from the body control unit 121. The point in time when the rear end of the preceding document G passes the pre-scan rollers 50 and the point in time when the forward end of the first document G1 starts conveying by the pre-scan rollers 50 are caused to coincide with each other. The first document G1 is conveyed to the READ document glass 110a in the state where the distance from the rear end of the preceding document G is reduced and approaches 0 mm.

When the value which the pre-scan piezoelectric sensor 114 detected is more than a threshold value, it is determined that a jam (ACT 230) exists. When the value which the pre-scan piezoelectric sensor 114 detected is below a threshold value, the processing goes to ACT 231. When the pre-scan piezoelectric sensor 114 detects pressure for more than a predetermined time, it is determined that a jam (ACT231) exists. When the pre-scan piezoelectric sensor 114 does not detect pressure for more than a predetermined time, the processing goes to ACT 232.

After the first document G1 is conveyed by a predetermined distance (ACT 232), a scan start signal is sent to the body control unit 121. The body control unit 121 causes the scanner 110 to start scanning an image on the face side of the document G1 (ACT 233).

In parallel, when the rear end of the first document G1 passes through the registration sensor 71 and the registration sensor 71 changes from on to off, supply of the second document G2 is started in ACT 300. The first document G1 travels on the READ document glass 110a. The scanner 110 scans an image of the first document G1. The second document G2 runs into the registration rollers 14 and its forward end is aligned. And then the second document G2 stops.

To convey the second document G2 in parallel, when the registration sensor 71 turns on (ACT 207), the processing reaches ACT 212 via ACT 208 and ACT 211. In ACT 212, if the document G2 is a sheet of an even ordinal number, the processing goes to ACT 250. In ACT 250, the gate solenoid 83 is turned on and the gate 40 is thus switched to the direction to direct the second document G2 to the IN conveying member 27. Then, in ACT 251, the RGT motor 82 and the intermediate IN motor 86 are turned on to rotate the registration rollers 14 and the intermediate IN rollers 28. The intermediate IN rollers 28 are adjusted to the rotation speed of the registration rollers 14, and the registration rollers 14 and the intermediate IN rollers 28 are rotated at a uniform velocity. The second document G2 is directed by the gate 40 and moves to the IN conveying member 27.

In ACT 233, the first document G1 continues traveling on the READ document glass 110a and the scanner 110 continues scanning the image. The first document G1 is conveyed in the direction of the paper discharge rollers 53 via the post-scan rollers 51 and the pre-discharge rollers 52.

When the value which the pre-discharge piezoelectric sensor 115 detected is more than a threshold value, it is determined that a jam exists (ACT 234). When the pre-discharge piezoelectric sensor 115 detected is below a threshold value, the processing goes to ACT 235. When the pre-discharge piezoelectric sensor 115 detects pressure for more than a predetermined time, it is determined that a jam exists (ACT 235). When the pre-discharge piezoelectric sensor 115 does not detect pressure for more than a predetermined time, the processing goes to ACT 236.

When the first document G1 turns on the paper discharge sensor 78 (ACT 236), the paper discharge motor 88 is driven to rotate the paper discharge rollers 53. In the case of double-side scan (Yes in ACT 238), the processing goes to ACT 239. In ACT 239, an image on the back side of the first document G1 conveyed in the paper discharge direction is scanned by the CIS 60. When a predetermined time passes (ACT 240) after the paper discharge sensor 78 is turned on, image scanning on the face side of the first document G1 by the scanner 110 is finished (ACT 241). After the rear end of the document is passed through the rollers 51, the READ motor 87 and the intermediate OUT motor 84 are turned off (ACT 242).

In parallel, when the value which the gate piezoelectric sensor 111 and the intermediate IN path piezoelectric sensor 113 detected is more than a threshold value, it is determined that a jam exists (ACT 252). When the value which the gate piezoelectric sensor 111 and the intermediate IN path piezoelectric sensor 113 detected is below a threshold value, the processing goes to ACT 253. When the gate piezoelectric sensor 111 and the intermediate IN path piezoelectric sensor 113 detects pressure for more than a predetermined time, it is determined that a jam exists (ACT 253). When the gate piezoelectric sensor 111 and the intermediate IN path piezoelectric sensor 113 do not detect pressure for more than a predetermined time, the processing goes to ACT 254.

With respect to the second document G2, when the paper timing sensor IN 73 is turned on in ACT 254, the RGT motor 82 and the intermediate IN motor 86 are driven by a predetermined number of pulses and then stopped (ACT 256). The second document G2 is stopped before the pre-scan rollers 50 in the IN conveying member 27. If the paper timing sensor IN 73 does not turn on even after a predetermined time passes in ACT 255, it is determined that the document G1 causes a jam. After a conveying request signal for the second document G2 is received from the body control unit 121 in ACT 257, the processing goes to ACT 258.

When a predetermined time passes after the forward end of the preceding document G (the first document G1) turns on the pre-scan sensor 76 in ACT 258, the processing goes to ACT 259. In ACT 259, the READ motor 87 and the intermediate IN motor 86 are turned on and the intermediate IN rollers 28, the pre-scan rollers 50, the post-scan rollers 51 and the paper discharge rollers 52 are rotated at a speed according to an instruction from the body control unit 121. The point in time when the rear end of the preceding document G (the first document G1) passes the pre-scan rollers 50 and the point in time when the forward end of the second document G2 starts the conveying by the pre-scan rollers 50 are caused to coincide with each other. The second document G2 is conveyed to the READ document glass 110a in the state where the distance between the rear end of the preceding document G (the first document G1) and the forward end of the second document G2 is minimized and approaches 0 mm.

To realize the state where the distance between the rear end of the preceding document G (the first document G1) and the forward end of the second document G2 approaches 0 mm, for example, the distance from the paper timing sensor OUT 72 to the pre-scan rollers 50 and the distance from the paper timing sensor IN 73 to the pre-scan rollers 50 are set to be equal. After the paper timing sensor IN 73 is turned on, the second document G2 waits at a position advanced by a predetermined distance. When the rear end of the preceding document G (the first document G1) is passed through the paper timing sensor OUT 72 and advances by the predetermined distance, the READ motor 87 and the intermediate IN motor 86 are turned on to convey the second document G2 in the direction of the READ document glass 110a. Thus, the distance between the rear end of the first document G1 and the forward end of the second document G2 can be made close to 0 mm.

Alternatively, the timing of conveying the preceding document G1 (the first document G1) and the second document G2 can be adjusted in advance in accordance with the result of detection by the paper timing sensor OUT 72 and the result of detection by the paper timing sensor IN 73, thus realizing the state where the distance between the preceding document G (the first document G1) and the second document 82 is close to 0 mm.

The second document G2 conveyed to the READ document glass 110a after the preceding document G (the first document G1) in ACT 259 is conveyed by a predetermined distance (ACT 232) and then image scanning on the face side by the scanner 110 is started (ACT 233). In parallel, when the rear end of the second document G2 is passed through the registration sensor 71 and the registration sensor 71 changes from on to off, supply of the document G3 as the third sheet (the third document G3) is started. The first document G1 is discharged in the direction of the paper discharge tray 56 by the paper discharge rollers 53. The second document G2 travels on the READ document glass 110a. The third sheet of the third document G3 runs into the registration rollers 14 and its forward end position aligned. And then the third document G3 stops.

To convey the third sheet of the document G3 in parallel, as the registration sensor 71 turns on (ACT 207), the processing reaches ACT 212 via ACT 208 and ACT 211. In ACT 212, if the third document G3 is a sheet of an odd ordinal number, the processing goes to ACT 214. In ACT 208, the gate solenoid 83 is turned off and the gate 40 is switched in the direction of dividing the third document G3 to the OUT conveying member 26. In ACT 214, the registration rollers 14 and the intermediate OUT rollers 18 are rotated to convey the third document G3 to the OUT conveying member 26. The first document G1 is set on the paper discharge tray 56. The second document G2 travels on the READ document glass 110a and turns on the paper discharge sensor 78. The third document G3 stops before the pre-scan rollers 50 in the OUT conveying member 26. After that, the third document G3 is conveyed to the READ document glass 110a in the state where the distance from the rear end of the preceding document G (the second document G2) is reduced and approaches 0 mm.

When the document G is not the final document, ACTs 214 to 222 (conveying of the document G by the OUT conveying member 26) and ACTs 250 to 259 (conveying of the document G by the IN conveying member 27) are alternately repeated and the documents are continuously conveyed in the state where the distance between the preceding document and the following document is close to 0 mm (ACT 260). When the document G is the final document and the paper discharge sensor 78 turns off (ACT 261), the final document is conveyed by a predetermined distance by the paper discharge rollers 53 (ACT 262). All the motors and solenoids are turned off (ACT 263). Then, conveying of the documents by the ADF 10 is completed.

According to this embodiment, in the case of continuously scanning the documents G, the two conveying members are used, that is, the OUT conveying member 26 and the IN conveying member 27. While the preceding first document G1 is conveyed by using one conveying member, the next second document G2 is caused to stand by in the other conveying member. The time when the preceding first document G1 passes through the scanner 110 and the time when the next second document G2 is conveyed to the scanner 110 are caused to coincide with each other. Thus, the documents G are continuously conveyed in the state where the distance between the preceding first document G1 and the next second document G2 is close to 0 mm.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimd is:

1. An auto-document feeder comprising:
a paper feeding section configured to feed documents one by one, from which images are read by an image scanning section;
a paper discharge section which discharges the documents passed through the image scanning section;
plural conveying sections which have different paths to reach the image scanning section configured to scan an image on a first side of the document from the paper feeding section and which guide the document from the paper feeding section to the image scanning section;
a scanning conveying section configured to alternately nip the documents fed one by one by the plural conveying sections and feed the documents in a direction of the paper discharge section through the image scanning section;
a gate section which directs the documents fed by the paper feeding section to one of the plural conveying sections; and
a detecting section configured to detect if a document is fed by the paper feeding section.

2. The feeder according to claim 1, wherein the detecting section is a piezoelectric sensor.

3. The feeder according to claim 2, wherein the plural conveying sections include a first conveying section and second conveying section, and the gate section directs the document from the paper feeding section to one of the first conveying section and second conveying section.

4. The feeder according to claim 3, wherein the gate section alternately directs the documents to the first conveying section or the second conveying section.

5. The feeder according to claim 3, wherein the first conveying section or second conveying section causes a following document to remain idle in the conveying section while a preceding document is scanned by the image scanning section.

6. The feeder according to claim 3, wherein the first conveying section or second conveying section causes a point in time when a rear end of the preceding document passes the image scanning member and a point in time when a forward end of the following document reaches the image scanning section to coincide with each other.

7. The feeder according to claim 3, wherein the first conveying section has a first timing sensor which detects the document and the second conveying section has a second timing sensor which detects the document.

8. The feeder according to claim 7, wherein the first conveying section or the second conveying section detects a time when the rear end of the preceding document passes the image scanning section by using the first timing sensor or the second timing sensor, detects a time when the forward end of the following document reaches the image scanning section by using the first timing sensor or the second timing sensor, and causes the time when the rear end of the preceding document passes the image scanning section and the time when the forward end of the following document reaches the image scanning section to coincide with each other.

9. The feeder according to claim 2, further comprising a second image scanning section which scans an image on a second side of the document, in the paper discharge section.

10. The feeder according to claim 9, wherein the image scanning section scans the image on the first side of the document, and the second image scanning section scans the image of the second side of the document.

11. An auto-document feeding method, comprising:
feeding documents one by one, from which images are read, by an image scanning section;
discharging the documents passed through the image scanning section;
scanning an image on a first side of the documents from a paper feeding section and guiding the documents from the paper feeding section to the image scanning section using plural conveying sections which have different paths to reach the image scanning section;
alternately nipping the documents fed one by one by the plural conveying sections and feeding the documents in a direction of a paper discharge section through the image scanning section;
directing the documents fed by the paper feeding section to one of the plural conveying sections; and
detecting if a document is fed by the paper feeding section.

12. The method according to claim 11, wherein directing the documents comprises directing the documents from the paper feeding section to one of a first conveying section and a second conveying section in order.

13. The method according to claim 11, wherein directing the documents comprises alternately directing the documents to a first conveying section or a second conveying section.

14. The method according to claim 11, further comprising causing a following document to remain idle in the conveying section while a preceding document is scanned by the image scanning section.

15. The method according to claim 11, further comprising causing a point in time when a rear end of the preceding document passes the image scanning member and a point in time when a forward end of the following document reaches the image scanning section to coincide with each other.

16. The method according to claim 11, further comprising scanning an image on a second side of the document.
